(19) United States
(12) Patent Application Publication
(10) Pub. No.: US 2024/0125162 A1
(43) Pub. Date: Apr. 18, 2024

(54) ROTARY ACTUATOR ASSEMBLY, HOUSEHOLD APPLIANCE AND CONTROL METHOD FOR HOUSEHOLD APPLIANCE

(71) Applicant: OECHSLER PLASTIC PRODUCTS (TAICANG) CO., LTD., Suzhou City,Jiangsu Province (CN)

(72) Inventors: JIANCHANG HUANG, Suzhou City, Jiangsu Province (CN); ZHENGGUO RUI, Suzhou City, Jiangsu Province (CN); HAIKUN SHI, Suzhou City, Jiangsu Province (CN)

(21) Appl. No.: 17/769,320

(22) PCT Filed: Sep. 15, 2020
(86) PCT No.: PCT/CN2020/115218

§ 371 Date: Apr. 14, 2022

(30) Foreign Application Priority Data
Nov. 5, 2019 (CN) 201911069140.3

(51) Int. Cl. E05F 15/614; F25D 23/02

(52) U.S. Cl. CPC E05F 15/614; F25D 23/028; E05Y 2201/706; E05Y 2400/445; E05Y 2900/31

(57) ABSTRACT

A rotary actuator assembly, a household appliance having same and a control method therefor. The rotary actuator assembly comprises an object to be rotated and a rotary actuator configured to match said object. The rotary actuator comprises an output shaft and a driving mechanism for driving the output shaft to rotate. Said object is provided with a shaft hole matching the output shaft. The output shaft and the shaft hole of said object are internally provided with a driving structure and a butt joint structure matching each other in the circumferential direction. A resisting surface and a butt joint surface for pushing said object to move during the rotation of the output shaft are formed between the driving structure and the butt joint structure. A rotation space for manual operation of said object is formed between the driving structure and the butt joint structure.

### TECHNICAL FIELD

The present invention relates to the field of automatic door opening and closing technologies, and more particularly to a rotary actuator assembly capable of implementing manual and automatic mode switching, a household appliance and a control method for the household appliance.

### BACKGROUND

The development of intelligent household appliances is matched with consumers' technological and intelligent operation requirements. Particularly, in people's lives, when a person wants to open a door while holding articles in both hands, he/she has to put down the articles at first, which is very inconvenient. In order to meet the above requirements, actuators for automatic door opening and closing are designed gradually for movable doors on household appliances and the like. However, such conventional actuators for automatic door opening and closing typically do not have a manual opening and closing function, especially when the actuators for automatic door opening and closing fail, it is difficult to implement related operations before maintenance.

Therefore, it is necessary to provide a rotary actuator assembly, a household appliance and a control method for the household appliance, which can solve the above problems.

### SUMMARY

The present invention provides a rotary actuator assembly capable of implementing manual and automatic mode switching, a household appliance and a control method for the household appliance.

In order to achieve the above-mentioned object, an embodiment of the present invention provides a rotary actuator assembly capable of implementing manual and automatic mode switching, comprising a to-be-rotated object and a rotary actuator matched with the to-be-rotated object, wherein the rotary actuator comprises an output shaft and a driving mechanism for driving the output shaft to rotate; the to-be-rotated object is provided with a shaft hole matched with the output shaft; a driving structure and an abutting structure that cooperate in a circumferential direction are arranged in the output shaft and the shaft hole of the to-be-rotated object, and propping surfaces and abutting surfaces that allow the output shaft to rotate to push the to-be-rotated object to move are formed between the driving structure and the abutting structure; and the total length of the driving structure and the abutting structure along the circumferential direction of the output shaft is less than the circumference of a circumferential surface where the driving structure and the abutting structure lie, so that a rotation space for allowing the to-be-rotated object to be manually operated to rotate is formed between the driving structure and the abutting structure.

As a further improvement of one embodiment of the present invention, the propping surfaces comprise a first propping surface and a second propping surface that are formed at two ends of the driving structure along the circumferential direction; the abutting surfaces comprise a first abutting surface and a second abutting surface that are formed at two ends of the abutting structure along the circumferential direction; the first abutting surface is opposite to the first propping surface; and the second propping surface is opposite to the second abutting surface.

As a further improvement of one embodiment of the present invention, in an initial state, the first propping surface is propped against the first abutting surface, and the rotation space is formed between the second propping surface and the second abutting surface.

As a further improvement of one embodiment of the present invention, an included angle between the second propping surface and the second abutting surface is a rotation or opening angle of the to-be-rotated object.

As a further improvement of one embodiment of the present invention, lengths of the driving structure and the abutting structure are the same along the circumferential direction of the output shaft, and are respectively one third of the total length along the circumferential direction.

As a further improvement of one embodiment of the present invention, the output shaft is a hollow rotating shaft, and the driving structure is formed at the end of the output shaft far away from the driving mechanism by cutting a part of the circumferential wall of the hollow rotating shaft.

As a further improvement of one embodiment of the present invention, the abutting structure protrudes from the inner wall of the shaft hole to be shaped like an arc, and is arranged on the extending direction of the driving structure along the circumferential direction of the output shaft.

As a further improvement of one embodiment of the present invention, the output shaft has a main shaft body and a transmission gear fixed to the outer side of the main shaft body in a sleeving way; and the driving mechanism has a driving motor and a decelerating mechanism connected between the driving motor and the transmission gear.

As a further improvement of one embodiment of the present invention, the rotary actuator assembly further comprises a microswitch, wherein the output shaft is sheathed with a shaft sleeve; the shaft sleeve is arranged between the transmission gear and the to-be-rotated object; and a switch position matched with the microswitch is arranged on the outer side of the shaft sleeve.

As a further improvement of one embodiment of the present invention, both the propping surfaces and the abutting surfaces extend along the axial direction of the output shaft.

In order to achieve the above-mentioned object, another embodiment of the present invention provides a household appliance having the rotary actuator assembly as mentioned above, comprising a main body and a control device, wherein the to-be-rotated object is a door body that is rotationally connected with the main body through the rotary actuator; and the driving mechanism is electrically connected to the control device.

In order to achieve the above-mentioned object, another embodiment of the present invention provides a control method for the household appliance as mentioned above, comprising: controlling a driving mechanism to drive an output shaft to rotate when an automatic door opening signal is received, so that an abutting structure is pushed by a driving structure and then a door body is pushed to rotate to be opened; controlling the driving mechanism to drive the output shaft to rotate reversely to be reset after the door body is opened in place; controlling the driving mechanism to drive the output shaft to rotate reversely when a door closing signal is received, so that the abutting structure is pushed by the driving structure and then the door body is pushed to rotate to be closed; and controlling the driving mechanism to drive the output shaft to rotate reversely to be reset after the door body is closed in place.

As a further improvement of one embodiment of the present invention, whether the door body is opened in place or not is judged by the following method: acquiring a working current of the driving mechanism in real time during the opening of the door body, and determining that the door body is opened in place when the working current is greater than a preset current.

As a further improvement of one embodiment of the present invention, whether the door body is closed in place or not is judged by the following method: acquiring a working current of the driving mechanism in real time during the closing of the door body, and determining that the door body is closed in place when the working current is greater than a preset current.

As a further improvement of one embodiment of the present invention, in the above-mentioned reverse rotation reset, further comprising: acquiring a reset signal from a microswitch in the rotary actuator, and controlling the driving mechanism to stop driving after the reset signal from the microswitch is received; and a working current of the driving mechanism is acquired in real time during both the opening and the closing of the door body, and the driving mechanism is controlled to rotate reversely when the working current is greater than a preset current.

Compared to the prior art, the present invention has the advantageous effects as follows: by arranging the above-mentioned driving structure and abutting structure between an output shaft and a shaft hole matched with the output shaft, both an automatic mode and a manual mode can be implemented directly without switching, so that the operation is simple and convenient; and the overall structure is simple and can be realized only by simply modifying the output shaft and the shaft hole matched with the output shaft in a conventional rotary actuator for automatic door opening and closing, so that a lower cost and wide applicability are achieved.

### BRIEF DESCRIPTION OF THE DRAWINGS

FIG. 1 is a partial structural perspective view of a household appliance according to a preferred embodiment of the present invention;

FIG. 2 is a perspective view of the household appliance shown in FIG. 1 with a housing of a rotary actuator removed;

FIG. 3 is an enlarged schematic diagram of a part marked with a square in FIG. 2;

FIG. 4 is a partial exploded perspective view of the household appliance shown in FIG. 1 with all structures except an output shaft of the rotary actuator removed;

FIG. 5 is an enlarged schematic diagram of a part marked with a square in FIG. 4;

FIG. 6 is a perspective view of an output shaft of a rotary actuator of the present invention;

FIG. 7 is a schematic top view of a shaft hole of a door body of the present invention;

FIG. 8 is a schematic diagram showing a cooperation state of the rotary actuator and the shaft hole when the door body of the present invention is in an initial closed state;

FIG. 9 is a schematic diagram showing a cooperation state of the rotary actuator and the shaft hole during the opening of the door body of the present invention;

FIG. 10 is a schematic view showing an operation state of the rotary actuator during resetting after the door body of the present invention is opened;

FIG. 11 is a diagram showing a cooperation state of the rotary actuator reset to an initial state and the shaft hole after the door body of the present invention is opened;

FIG. 12 is a schematic diagram showing a cooperation state of the rotary actuator and the shaft hole during the closing of the door body of the present invention;

FIG. 13 is a schematic diagram showing an operation state of the rotary actuator during resetting after the door body of the present invention is closed; and

FIG. 14 is a diagram showing a cooperation state of the rotary actuator reset to the initial state and the shaft hole after the door body of the present invention is closed.

### DETAILED DESCRIPTION

In order to make persons skilled in the art better understand the technical solutions of the present invention, the technical solutions in the embodiments of the present invention will be clearly and completely described below with reference to the accompanying drawings in the embodiments of the present invention. Obviously, the described embodiments are only some of the embodiments of the present invention, but not all of the embodiments. Based on the embodiments of the present invention, all other embodiments obtained by persons of ordinary skilled in the art without creative efforts shall fall within the protection scope of the present invention.

The present invention relates to a rotary actuator assembly 100 capable of implementing manual and automatic mode switching. The rotary actuator assembly 100 is applicable to various household appliances, such as refrigerators, freezers, disinfection cabinets and other electrical equipment. Therefore, the present invention may further relate to a household appliance 800 which has the above-mentioned rotary actuator assembly 100.

The rotary actuator assembly 100 includes a to-be-rotated object and a rotary actuator 1 matched with the to-be-rotated object.

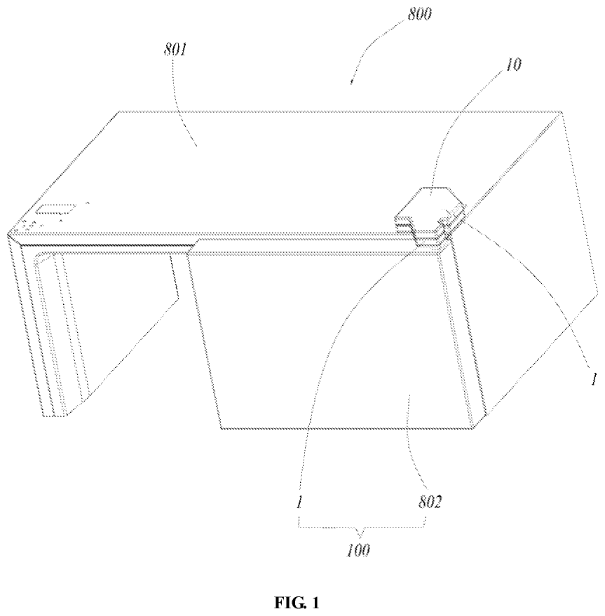

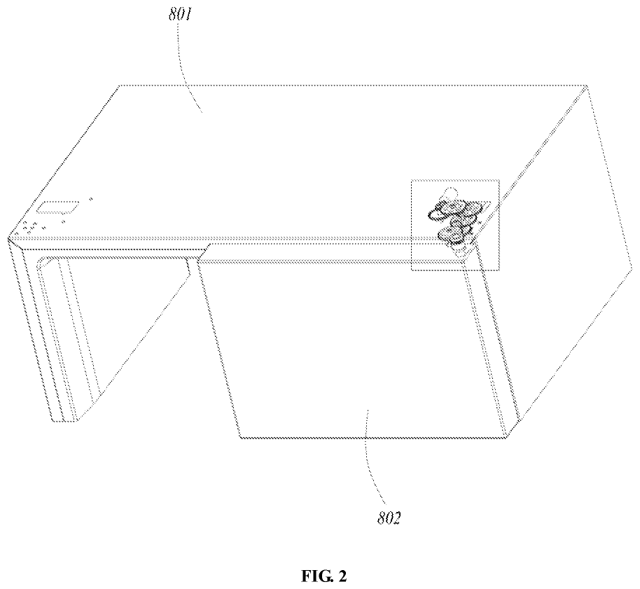

Referring to FIGS. 1 to 3, the household appliance 800 of the present invention, taking a refrigerator as an example, has a main body 801, a door body 802 rotationally connected to the main body 801, and a control device (not shown), wherein the door body 802 is the above-mentioned to-be-rotated object. In the following description, a preferred representative embodiment will be described with the door body 802 as the to-be-rotated object on the whole. Of course, the to-be-rotated object may be other door bodies, cover bodies or the like that need to be operated in manual and automatic modes.

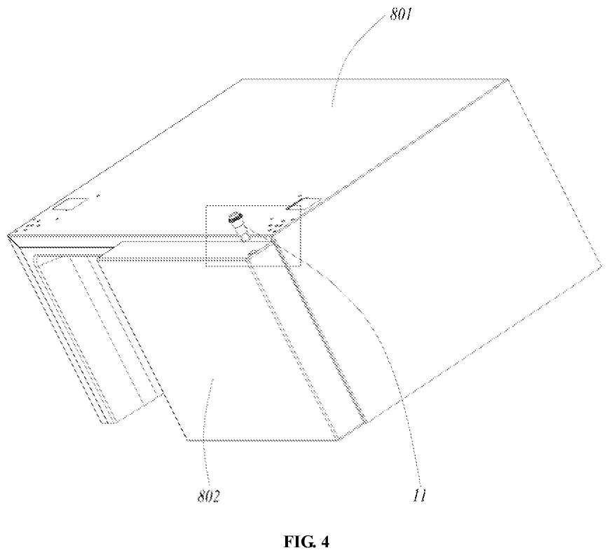

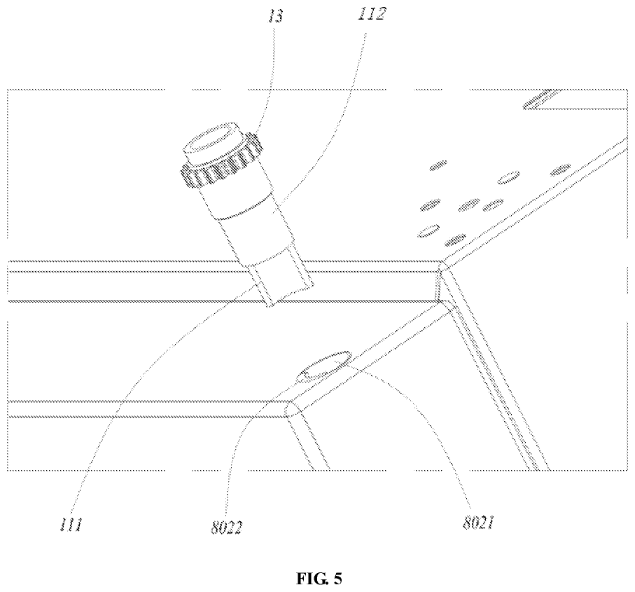

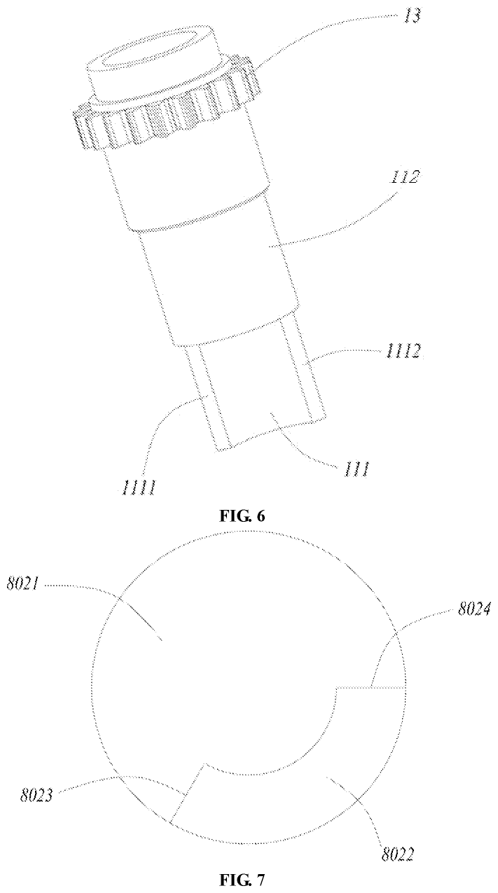

Referring to FIGS. 4 to 14, according to an overall design solution, the rotary actuator 1 includes an output shaft 11 and a driving mechanism 12 for driving the output shaft 11 to rotate. The door body 802 is provided with a shaft hole 8021 matched with the output shaft 11. A driving structure 111 and an abutting structure 8022 that cooperate in a circumferential direction are arranged in the output shaft 11 and the shaft hole 8021 of the door body 802. Propping surfaces and abutting surfaces that allow the output shaft 11 to rotate to push the door body 802 to move are formed between the driving structure 111 and the abutting structure 8022. The total length of the driving structure 111 and the abutting structure 8022 along the circumferential direction of the output shaft 11 is less than the circumference of a circumferential surface where the driving structure 111 and the abutting structure 8022 lie, so that a rotation space for allowing the door body 802 to be manually operated to rotate is formed between the driving structure 111 and the abutting structure 8022.

In this way, when automatic door opening and closing operations are required, the output shaft 11 of the rotary actuator 1 may be driven to rotate by the driving mechanism 12, and then the door body is opened by the cooperation of the driving structure and the abutting structure; and the door body is closed by reverse rotation. When manual door opening and closing operations are required, all that is needed is to directly rotate the door body 802 manually to drive the abutting structure 8022 in the shaft hole 8021 to move in the above-mentioned rotation space. Thus, it can be seen that the rotary actuator assembly 100 of the present invention can directly implement both an automatic mode and a manual mode without switching, is simple and convenient to operate, has a simple overall structure, can be realized only by simply modifying the output shaft and the shaft hole matched with output shaft in the conventional rotary actuator for automatic door opening and closing, and achieves a lower cost and wide applicability.

Specifically, as shown in FIG. 1 to 3, the rotary actuator 1 is fixed to the main body 801 of the household appliance 800, and the output end of the output shaft 11 protrudes toward the door body 802. The driving mechanism 12 is electrically connected to the control device.

The rotary actuator 1 has a housing 10. The driving mechanism 12 is arranged in the housing 10, and has a driving motor 121 and a decelerating mechanism 122 connected between the driving motor 121 and the output shaft 11. In order to reduce the size of the rotary actuator 1 and the height, the driving motor 121 is horizontally arranged in the housing 10. A plurality of gears cooperates with one another for transmission to form the decelerating mechanism 122.

The output shaft 11 has a main shaft body 12 and a transmission gear fixed to the main shaft body 12 in a sleeving way. The transmission gear 13 is fixed to the upper end of the main shaft body 12 and stretches into the housing 10. The transmission gear 13 is meshed with an output gear of the decelerating mechanism 122 so as to be in driving connection with the driving mechanism 12.

As shown in FIGS. 4 to 6, the output shaft 11 in the embodiment is a hollow rotating shaft, and the driving structure 111 is formed at the end of the output shaft 11 far away from the driving mechanism 12 by cutting a part of the circumferential wall of the hollow rotating shaft 11. Of course, the output shaft 11 may also be a solid rotating shaft, and in this case, the driving structure 111 may be formed by outward protruding of the outer wall surface of the solid rotary shaft. Of course, the end of the solid rotating shaft far away from the driving mechanism 12 may also be cut, so that a remaining part after cutting forms the driving structure 111 to achieve the purpose of the present invention as well.

Accordingly, as shown in FIGS. 4 and 5, the abutting structure 8022 protrudes from the inner wall of the shaft hole 8021 to be shaped like an arc, and is arranged on the extending direction of the driving structure 111 along the circumferential direction of the output shaft 11, so that when the driving mechanism 12 drives the output shaft 11 to rotate, the abutting structure 8022 can be pushed to drive the door body 802 to rotate along the circumferential direction of the output shaft 11.

The lengths of the driving structure 111 and the abutting structure 8022 along the circumferential direction may be cooperatively set according to a stress demand, the opening angle of the door body 802, and the like. In the preferred embodiment, the lengths of the driving structure 111 and the abutting structure 8022 are the same along the circumferential direction of the output shaft 11, and are respectively one third of the total length along the circumferential direction; and in this case, the opening angle of the door body 802 is set to be 120 degrees.

Furthermore, the above-mentioned propping surfaces of the driving structure 111, which are used for cooperating with the abutting structure 8022, include a first propping surface 1111 and a second propping surface 1112 that are formed at two ends of the driving structure 111 along the circumferential direction. The above-mentioned abutting surfaces of the abutting structure 8022 include a first abutting surface 8023 and a second abutting surface 8024 that are formed at two ends of the abutting structure 8022 along the circumferential direction. The first abutting surface 1111 is opposite to the first propping surface 8023, and the second propping surface 1112 is opposite to the second abutting surface 8024.

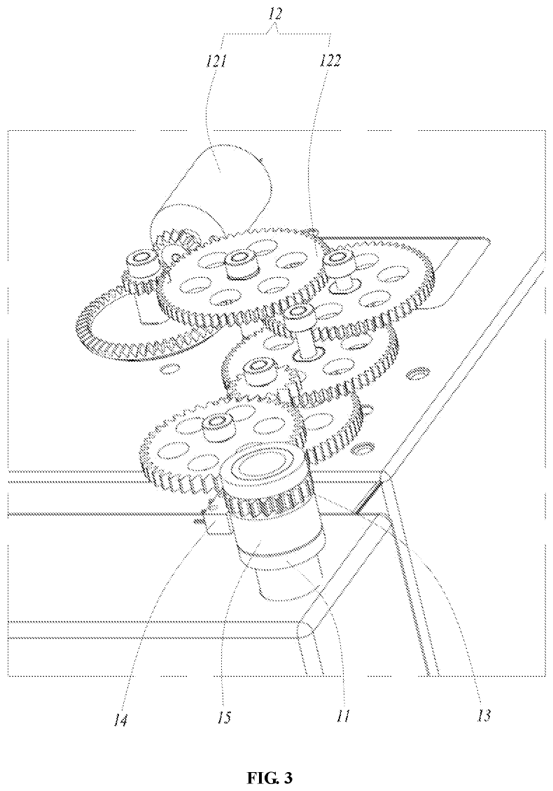

As shown in FIGS. 3 to 7, preferably the rotary actuator 1 is set in such a way that: in an initial state, the first propping surface 1111 is propped against the first abutting surface 8023, and at this moment, the rotation space is formed between the second propping surface 1112 and the second abutting surface 8024. The included angle between the second propping surface 1112 and the second abutting surface 8024 is a rotation or opening angle of the door body 802.

Further preferably, in the embodiment, both the propping surfaces and the abutting surfaces extend in the axial direction of the output shaft 11 and are located in the radial directions of the output shaft 11 and the shaft hole 8021, which facilitates mounting and ensures that the propping surfaces and the abutting surfaces do not shift relative to each other in the axial direction of the output shaft 11 when driven to rotate.

In addition, as shown in FIG. 3, in order to facilitate the monitoring of a rotation position of the output shaft 11, a microswitch 14 is also arranged in the rotary actuator assembly 100 according to the preferred embodiment of the present invention. The microswitch 14 is fixed in the housing 10 and located at a position adjacent to the output shaft 11. Further, the part of the output shaft 11, which is located in the housing 10, is sheathed with a shaft sleeve 15; the shaft sleeve 15 is also disposed between the transmission gear 13 and the door body 802; and a switch position matched with the microswitch 14 is arranged on the outer side of the shaft sleeve 15.

As shown in FIGS. 1 to 14, in combination with the description of the settings of the household appliance 800 and the rotary actuator assembly 100 thereof, the present invention further relates to a control method for the household appliance. The method includes the following steps:

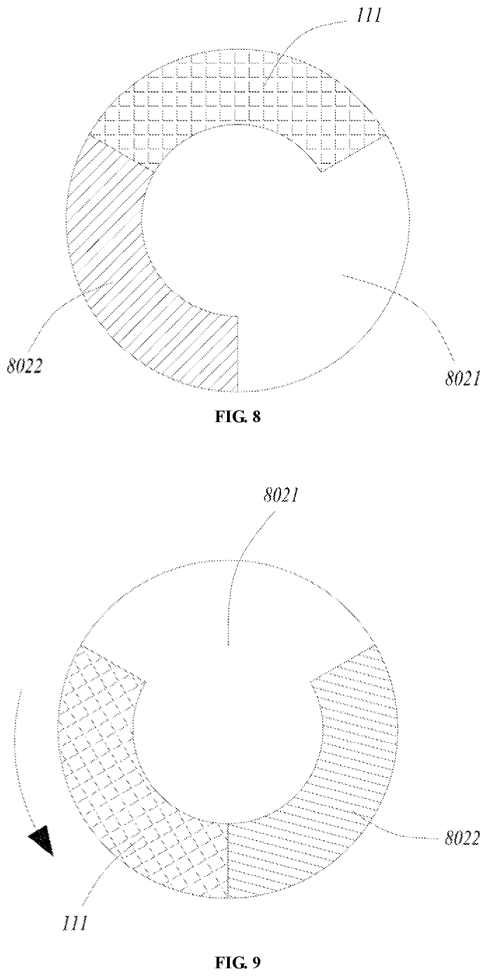

controlling the driving mechanism 12 to drive the output shaft 11 to rotate when an automatic door opening signal is received, so that the abutting structure 8022 is pushed by the driving structure 111 and then the door body 802 is pushed to rotate to be opened, with reference to the working process shown in FIGS. 8 and 9;

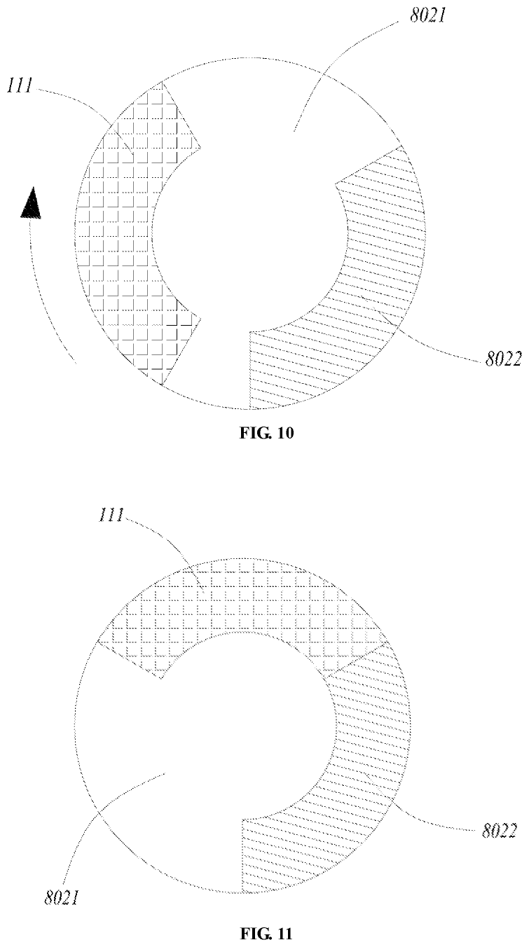

controlling the driving mechanism 12 to drive the output shaft 11 to rotate reversely to be reset after the door body 802 is rotated in place, as shown in FIGS. 10 and 11, wherein the term “reversely” refers to a rotation direction relative to the direction in which the door body is opened;

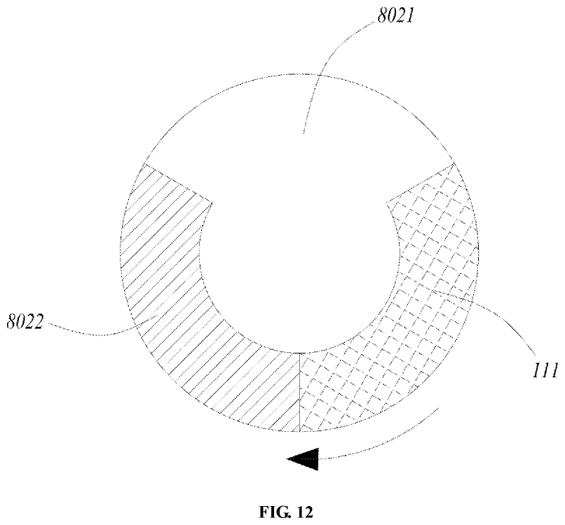

controlling the driving mechanism 12 to drive the output shaft 11 to rotate reversely when a door closing signal is received, so that the abutting structure 8022 is pushed by the driving structure 111 and then the door body 802 is pushed to rotate to be closed, as shown in FIG. 12, wherein the term “reversely” refers to a rotation direction relative to the direction in which the door body is opened; and

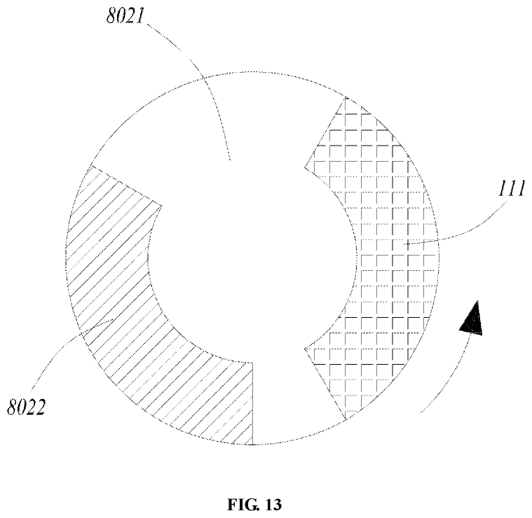

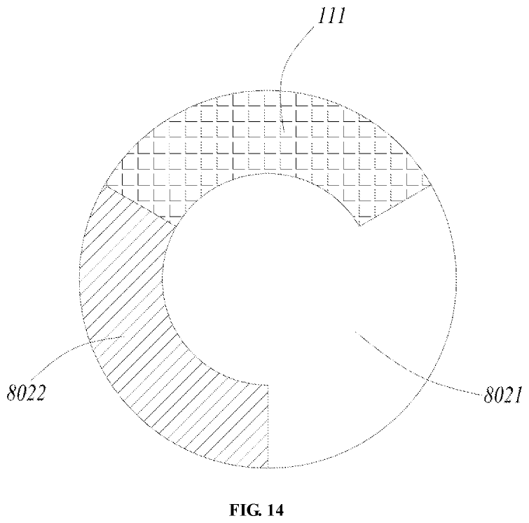

controlling the driving mechanism 12 to drive the output shaft 11 to rotate reversely to be reset after the door body 802 is rotated in place, as shown in FIGS. 13 and 14. Of course, wherein the terra. “reversely” refers to a rotation direction relative to the direction in which the door body is closed.

Specifically, when the door body 802 is opened, a working current of the driving mechanism 12 is acquired. Since after the door body 802 is rotated in place, resistance to the outward rotation of the door body 802 increases, the working current of the driving mechanism 12 correspondingly increases, and at this moment the working current is greater than a preset current, it can be determined that the door body 802 is rotated to be opened in place when the working current is greater than the preset current. At this moment, the driving mechanism 12 may be controlled to rotate reversely to be reset.

As described above, preferably, the rotary actuator 1 is set in such a way that: in the initial state, the first propping surface 1111 is propped against the first abutting surface 8023; and at this moment, the driving mechanism 12 may drive the output shaft 11 to rotate without idling, and an acting force may be directly applied to the abutting structure 8022 of the door body 802.

Furthermore, in the embodiment, the lengths of the driving structure 111 and the abutting structure 8022 along the circumferential direction of the output shaft 11 are set to be the same, and are respectively one third of the total length along the circumferential direction, and the opening angle of the door body 802 is set to be 120 degrees. In this case, after the door body 802 is opened, and the driving mechanism 12 is rotated reversely to be reset, the second propping surface 1112 is just propped against the second abutting surface 8024, so that after a door closing signal is received, the driving mechanism 12 drives the output shaft 11 to rotate reversely without idling, and an acting force is directly applied to the second abutting surface 8024 of the door body 802. In addition, such a structure may allow the door body to be closed manually directly after the door body is automatically opened.

Further, the reset of the driving mechanism is judged through the microswitch 14 and the switch position on the output shaft 11, and after receiving a reset signal from the microswitch 14, the control device determines that the driving mechanism 12 reaches an initial position and then controls the driving mechanism 12 to stop operating.

Furthermore, in the above-mentioned steps, during the closing of the door body 802, the working current of the driving mechanism 12 is acquired in real time. Since after the door body 802 is rotated in place, the resistance to the rotation of the door body 802 to the main body 801 increases, the working current of the driving mechanism 12 correspondingly increases, and at this moment the working current is greater than a preset current, it can be determined that the door body 802 is rotated to be closed in place when the working current is greater than a preset current value I. At this moment, the driving mechanism 12 may be controlled to rotate reversely to be reset.

Further, the control method of the present invention may further include anti-pinch or anti-collision judgment for preventing the case that an operator is caught by or collides with the door body to be hurt. Specifically, when the door body 802 encounters resistance during opening or closing, the working current of the drive mechanism 12 increases, and when the working current is greater than the set current, the driving mechanism 12 is also controlled to rotate reversely in addition to the case that the door body is opened or closed in place. That is, the driving mechanism 12 is controlled to rotate reversely in any of the cases that the door body is opened in place, the door body is closed in place and the current is increased by the resistance to the door body.

However, during reverse rotation or reset, the driving mechanism 12 is controlled to stop rotating if a signal from the microswitch 14 is received.

To sum up, in the rotary actuator assembly 100 and the household appliance 800 having the same according to the present invention, by arranging the above-mentioned driving structure 111 and abutting structure 8022 between the output shaft 11 and the matching shaft hole 8021, both the automatic mode and the manual mode can be implemented directly without switching, so that the operation is simple and convenient; and the overall structure is simple and can be realized only by simply modifying the output shaft and the shaft hole matched with the output shaft of a conventional rotary actuator for automatic door opening and closing, so that a lower cost and wide applicability are achieved.

It should be understood that although the present specification is described based on embodiments, not every embodiment contains only one independent technical solution, Such a narration way of the present specification is only for the sake of clarity. Those skilled in the art should take the present specification as an entirety. The technical solutions in the respective embodiments may be combined properly to form other embodiments which may be understood by those skilled in the art.

A series of the detailed descriptions set forth above is merely specific description of feasible embodiments of the present invention, and is not intended to limit the protection scope of the present invention. Equivalent embodiments or modifications made within the spirit of the present invention shall fall within the protection scope of the present invention.

1. A rotary actuator assembly capable of implementing manual and automatic mode switching, comprising a to-be-rotated object and a rotary actuator matched with the to-be-rotated object, wherein the rotary actuator comprises an output shaft and a driving mechanism for driving the output shaft to rotate; the to-be-rotated object is provided with a shaft hole matched with the output shaft;
a driving structure and an abutting structure that cooperate in a circumferential direction are arranged in the output shaft and the shaft hole of the to-be-rotated object, and propping surfaces and abutting surfaces that allow the output shaft to rotate to push the to-be-rotated object to move are formed between the driving structure and the abutting structure; and
the total length of the driving structure and the abutting structure along the circumferential direction of the output shaft is less than the circumference of a circumferential surface where the driving structure and the abutting structure lie, so that a rotation space for allowing the to-be-rotated object to be manually operated to rotate is formed between the driving structure and the abutting structure.

2. The rotary actuator assembly according to claim 1, wherein the propping surfaces comprise a first propping surface and a second propping surface that are formed at two ends of the driving structure along the circumferential direction; the abutting surfaces comprise a first abutting surface and a second abutting surface that are formed at two ends of the abutting structure along the circumferential direction; the first abutting surface is opposite to the first propping surface; and the second propping surface is opposite to the second abutting surface.

3. The rotary actuator assembly according to claim 2, wherein in an initial state, the first propping surface is propped against the first abutting surface, and the rotation space is formed between the second propping surface and the second abutting surface.

4. The rotary actuator assembly according to claim 3, wherein an included angle between the second propping surface and the second abutting surface is a rotation or opening angle of the to-be-rotated object.

5. The rotary actuator assembly according to claim 1, wherein lengths of the driving structure and the abutting structure are the same along the circumferential direction of the output shaft, and are respectively one third of the total length along the circumferential direction.

6. The rotary actuator assembly according to claim 1, wherein the output shaft is a hollow rotating shaft, and the driving structure is formed at the end of the output shaft far away from the driving mechanism by cutting a part of the circumferential wall of the hollow rotating shaft.

7. The rotary actuator assembly according to claim 6, wherein the abutting structure protrudes from the inner wall of the shaft hole to be shaped like an arc, and is arranged on the extending direction of the driving structure along the circumferential direction of the output shaft.

8. The rotary actuator assembly according to claim 1, wherein the output shaft has a main shaft body and a transmission gear fixed to the outer side of the main shaft body in a sleeving way; and the driving mechanism has a driving motor and a decelerating mechanism connected between the driving motor and the transmission gear.

9. The rotary actuator assembly according to claim 8, wherein the rotary actuator assembly further comprises a microswitch, wherein the output shaft is sheathed with a shaft sleeve; the shaft sleeve is arranged between the transmission gear and the to-be-rotated object; and a switch position matched with the microswitch is arranged on the outer side of the shaft sleeve.

10. The rotary actuator assembly according to claim 1, wherein both the propping surfaces and the abutting surfaces extend along the axial direction of the output shaft.

11. A household appliance having the rotary actuator assembly according to claim 1, comprising a main body and a control device, wherein the to-be-rotated object is a door body that is rotationally connected with the main body through the rotary actuator; and the driving mechanism is electrically connected to the control device.

12. A control method for the household appliance according to claim 11, comprising:
controlling a driving mechanism to drive an output shaft to rotate when an automatic door opening signal is received, so that an abutting structure is pushed by a driving structure and then a door body is pushed to rotate to be opened;
controlling the driving mechanism to drive the output shaft to rotate reversely to be reset after the door body is opened in place;
controlling the driving mechanism to drive the output shaft to rotate reversely when a door closing signal is received, so that the abutting structure is pushed by the driving structure and then the door body is pushed to rotate to be closed; and
controlling the driving mechanism to drive the output shaft to rotate reversely to be reset after the door body is closed in place.

13. The control method for the household appliance according to claim 12, wherein whether the door body is opened in place or not is judged by the following method: acquiring a working current of the driving mechanism in real time during the opening of the door body, and determining that the door body is opened in place when the working current is greater than a preset current.

14. The control method for the household appliance according to claim 12, wherein whether the door body is closed in place or not is judged by the following method: acquiring a working current of the driving mechanism in real time during the closing of the door body, and determining that the door body is closed in place when the working current is greater than a preset current.

15. The control method for the household appliance according to claim 12, further comprising: in the above-mentioned reverse rotation reset, acquiring a reset signal from a microswitch in the rotary actuator, and controlling the driving mechanism to stop driving after the reset signal from the microswitch is received.

16. The control method for the household appliance according to claim 12, wherein a working current of the driving mechanism is acquired in real time during both the opening and the closing of the door body, and the driving mechanism is controlled to rotate reversely when the working current is greater than a preset current.
